(19) United States
(12) Patent Application Publication
(10) Pub. No.: US 2006/0039552 A1
(43) Pub. Date: Feb. 23, 2006

(54) Opening and closing device and electronic equipment using the same

(76) Inventors: Koji Sakai, Tsuruga-shi (JP); Masaki Nakase, Obama-shi (JP); Ichiro Tateishi, Toyota-shi (JP)

Correspondence Address: RATNERPRESTIA, P.O. BOX 980, VALLEY FORGE, PA, 19482, US

(21) Appl. No.: 11/205,406

(22) Filed: Aug. 17, 2005

(30) Foreign Application Priority Data
Aug. 20, 2004 (JP) 2004-240471

(51) Int. Cl. H04M 1/00; H04M 9/00

(52) U.S. Cl. 379/433.13

(57) ABSTRACT

An opening and closing device and electronic equipment using the device. The stator and the rotor of the device, which are accommodated in the rotary case, have a hollow cylinder shape. Employing such a shape allows the device to have a hollow section that runs through in the axial direction. In electronic equipment using the device, the wiring section including a lead wire and a wiring board for electrically connecting between the fix housing and the movable housing can be laid through the hollow section. That is, the structure of the device can eliminate a space for retaining the wiring section, encouraging downsizing of the equipment.

### FIELD OF THE INVENTION

The present invention relates to an opening and closing device used for electronic equipment, such as a mobile phone and a personal computer, and also relates to electronic equipment using the device.

### BACKGROUND ART

In recent years, electronic equipments including a mobile phone and a personal computer have become more compact and lightweight. In such a trend, foldable electronic equipments having a movable housing foldably attached to a fix housing have become popular. Accordingly, as for an opening and closing device employed for such a foldable structure, further miniaturization has been in need.

Here will be described a conventional opening and closing device and electronic equipment using the device, with reference to FIG. 5 through FIG. 7.

In the drawings, for a better understanding of the relationship between a stator cam and a rotor cam, the structure shown in a sectional view is radially enlarged.

FIG. 5 shows a sectional view of a conventional opening and closing device, and FIG. 6 shows an exploded perspective view of the device. Opening and closing device 10 contains stator 1; rotor 3; rotary case 5; cover 6; coil spring 7; and fix shaft 8. Stator 1, rotor 3, rotary case 5 are made of metal or resin and have a substantially cylindrical shape. Fix shaft 8 is formed in a substantially columnar shape.

Stator 1 has stator cam 2 on the right-side periphery. Stator cam 2 is formed of projecting portion 2A and tilting portions 2B and 2C extended downward and upward, respectively, from projecting portion 2A. Rotor 3 is disposed so as to be rotatable with respect to stator 1 in opening and closing directions. Rotor 3 contains rotor cam 4 on the left-side periphery confronting stator cam 2, and holding portion 3A that extends outwards from the periphery of rotor 3. Rotary case 5 has guide 5A extending from the periphery of the case. Guide 5A has a groove inside. Holding portion 3A of rotor 3 is inserted into the groove and rotor 3 is accommodated in rotary case 5 so as to be movable in an axial direction of rotary case 5. Cover 6 covers the opening at the right side of rotary case 5. Spring 7 is disposed, in a little contracted state, between the right side of rotor 3 and cover. Spring 7 urges rotor 3 toward the left, so that the tip of rotor cam 4 makes contact with tilting portion 2B of stator cam 2.

Stator 1 is fixed at the left end of fix shaft 8. Fix shaft 8 runs through the hollow section of rotor 3 and spring 7, and the right end of fix shaft 8 is fixed to cover 6. Stator 1, rotor 3 and spring 7 are accommodated in rotary case 5, with fixed part 1A of stator 1 stuck out of the left side of rotary case 5. Opening and closing device 10 is thus formed.

Now a description is given on an example where such structured opening and closing device 10 is used for a mobile phone. The mobile phone shown in FIG. 7 has fix housing 12 and movable housing 13. Operating part 12A with a plurality of keys, and sound input part 12B such as a microphone are disposed on the surface of fix housing 12. On the surface of movable housing 13, display 13A including liquid crystal display (LCD), and a sound output part 13B such as a speaker are disposed. Fixed part 1A of stator 1 is fixed with fix housing 12; on the other hand, rotary case 5 is fixed with movable housing 13, whereby fix housing 12 and movable housing 13 are journaled via opening and closing device 10.

Wiring section 14 including a lead wire and a wiring board is disposed, in a little slack state, at the connecting part next to opening and closing device 10 for fix housing 12 and movable housing 13. Through wiring section 14, electronic circuits (not shown) disposed in fix housing 12 and movable housing 13, sound input part 12B, display 13A, and sound output part 13B are electrically connected. The mobile phone is thus completed.

In the state of FIG. 5, in which the tip of rotor cam 4 makes contact with downward tilting portion 2B, rotor 3 is urged downward (i.e., in the closing direction) by spring 7. The urging force toward the closing direction is added, as a rotative force, from holding part 3A to the inside groove of guide 5A of rotary case 5, so that movable housing 13 to which rotary case 5 is fixed retains the closed state with respect to fix housing 12.

When movable housing 13 is manually unfolded from the closed state, an upward rotative force is applied, via the groove of guide 5A of rotary case 5 fixed to movable housing 13, to holding portion 3A. Under the force, rotor 3 moves with rotation toward the right in rotary case 5, while contracting spring 7. The tip of rotor cam 4 slides over tilting portion 2B of stator cam 2 toward projecting portion 2A.

Once the tip of rotor cam 4 gets over projecting portion 2A and makes contact with upward tilting portion 2C, from then on, rotor 3 is urged upward (i.e., in the opening direction) by spring 7. The upward force is applied from holding portion 3A to the inside of guide 5A of rotary case 5, so that movable housing 13 to which rotary case 5 is fixed retains the opening state. Each time movable housing 13 is opened and closed, the force generated by the operations rotates rotary case 5 fixed to movable housing 13. The rotative force is applied to holding portion 3A via the inside of guide 5A. Under the force, rotor 3 moves in the axial direction, thereby contacting the tip of rotor cam 4 with either tilting portion 2B or tilting portion 2C of stator cam 2. Movable housing 13 thus retains the opening (or closing) state with respect to fix housing 12.

Upon input operation given through operating part 12A on the surface of fix housing 12, the input signal is carried, through wiring system 14 attached on the connecting part between fix housing 12 and movable housing 13, to the electronic circuits in movable housing 13. As a result, display 13A shows text and/or numerical data corresponding to the input operation.

The conventional structure described above is disclosed, for example, in Japanese Patent Unexamined Publication No. 2004-190828.

In the conventional device and electronic equipment using the device, however, opening and closing device 10 for opening and closing operations and wiring system 14 for electrical connections are disposed at the connecting part between fix housing 12 and movable housing 13. The necessity for the space in which the two components are accommodated has been an obstacle to miniaturization of the whole structure.

### SUMMARY OF THE INVENTION

According to the present invention, the stator and the rotor housed in the rotary case are formed into a hollow cylinder so that the opening and closing device has a hollow section that runs through in the axial direction. When the device is attached to electronic equipment, the wiring system including a lead wire and a wiring board can be laid through the hollow section of the stator and the rotor. By virtue of no need of a space for accommodating the wiring system, the opening and closing device of the present invention encourages downsizing of the electronic equipment.

The electronic equipment of the present invention uses the opening and closing device of the invention, and the device has a mid hollow section through which the wiring system is disposed. With the structure, the electronic equipment can be more compact.

### BRIEF DESCRIPTION OF THE DRAWINGS

FIG. 1 is a sectional view of an opening and closing device of an exemplary embodiment of the present invention.

FIG. 2 is an exploded perspective view of the opening and closing device of the exemplary embodiment.

FIG. 3 is a perspective view of a mobile phone of the exemplary embodiment.

FIG. 4 is a sectional view of an opening and closing device of another exemplary embodiment.

FIG. 5 is a sectional view of a conventional opening and closing device.

FIG. 6 is an exploded perspective view of the conventional device.

FIG. 7 is a perspective view of a conventional mobile phone.

### DETAILED DESCRIPTION OF THE INVENTION

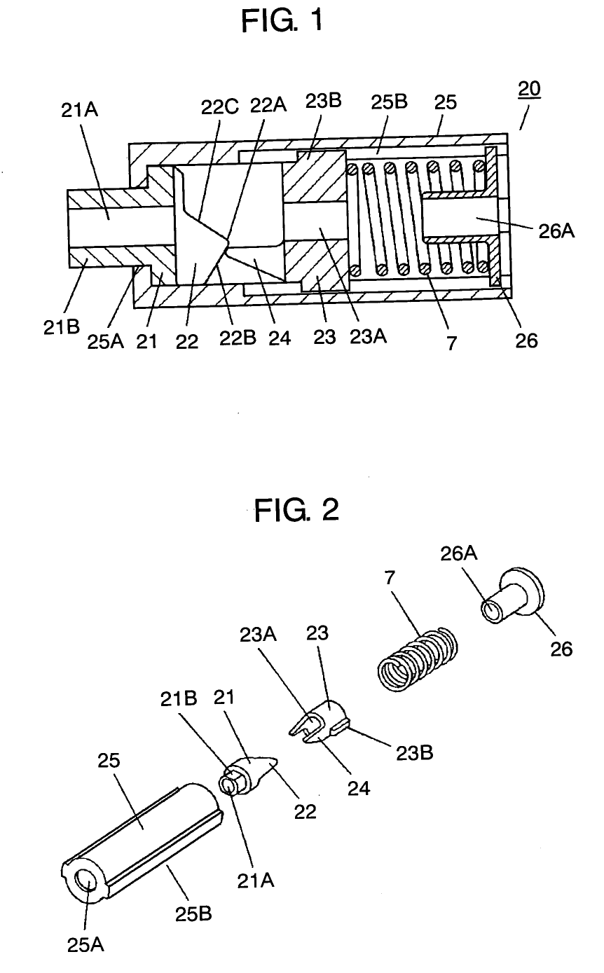

An exemplary embodiment of the present invention is described hereinafter with reference to the accompanying drawings, FIG. 1 through FIG. 4.

In the drawings, for a better understanding of the relationship between a stator cam and a rotor cam, the structure shown in a sectional view is radially enlarged.

In the description, elements similar to those described in Background Art have the same reference marks, and the explanations of those elements are omitted.

### Exemplary Embodiment

FIG. 1 is a sectional view of an opening and closing device of an exemplary embodiment of the present invention. FIG. 2 is an exploded perspective view of the device. Opening and closing device 20 contains stator 21; rotor 23; rotary case 25; cover 26; and coil spring 7. Stator 21 and rotor 23 are made of metal or resin and formed into a hollowed cylinder. Rotary case 25 is also made of metal or resin, but has a substantially columnar shape.

Stator 21 has hollow section 21A in its center, and stator cam 22 on the right-side periphery. Stator cam 22 is formed of projecting portion 22A and two tilting portions 22B, 22C that extend downward and upward, respectively, from projecting portion 22A. Rotor 23 is disposed so as to be rotatable with respect to stator 21 in the opening and closing directions. Rotor 23 has hollow section 23A in its center, and rotor cam 24 on the left-side periphery that faces stator cam 22. Besides, holding portion 23B extends from two positions on the periphery.

Rotary case 25 has through-hole 25A in the left and guide portion 25B outwardly extends from two positions on the periphery of the case. In the inside of guide portion 25B, there is a groove, into which holding portion 23A that has a width smaller than that of the groove is inserted. With the structure, rotor 23 is accommodated in rotary case 25 so as to be movable in the axial direction of the case.

Cover 26 has hollow section 26A in the center. Attached on the right side of rotary case 25, cover 26 covers the opening of the case. Cover 26 is formed of a disk portion and a cylindrical portion. Hollow section 26A runs through the disk and the cylindrical portions. Spring 7 is disposed, in a little contracted state, between the right side of rotor 23 and cover 26. Spring 7 urges rotor 23 toward the left, so that the tip of rotor cam 24 makes contact with tilting portion 22B of stator cam 22. Stator 21, rotor 23, and spring 7 are accommodated in rotary case 25, with fixed part 21B having an upper flat portion and a lower flat portion on the periphery movably stuck out of the left side of rotary case 25. Opening and closing device 20 is thus completed.

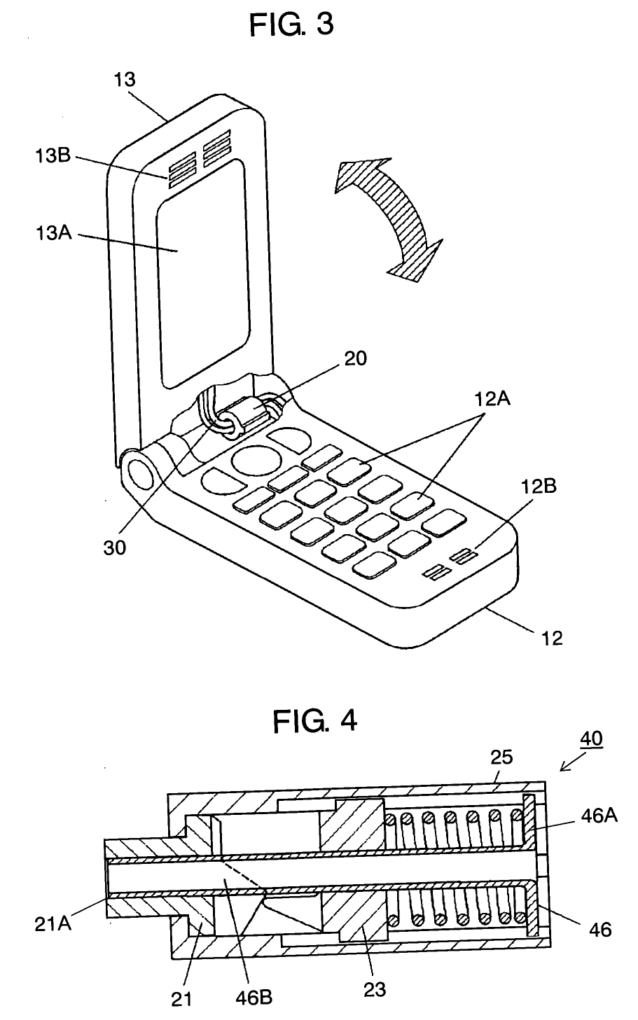

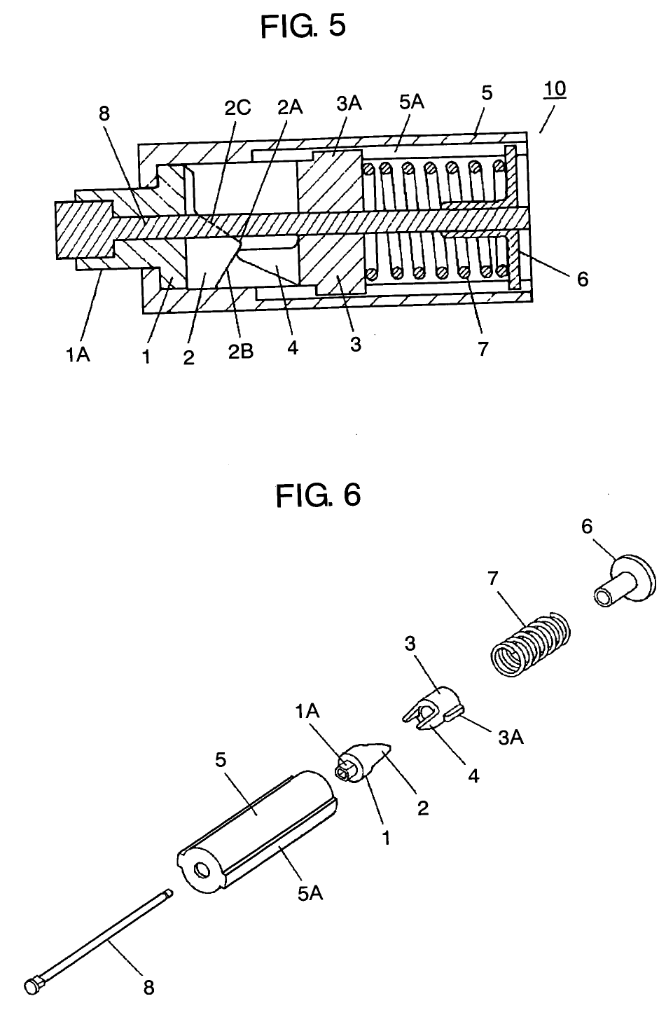

Now a description is given on an example where such structured opening and closing device 20 is used for a mobile phone, for example, as shown in FIG. 3. The mobile phone of FIG. 3 has fix housing 12 and movable housing 13. Operating part 12A with a plurality of keys, and sound input part 12B such as a microphone are disposed on the surface of fix housing 12. On the surface of movable housing 13, display 13A including liquid crystal display (LCD), and a sound output part 13B such as a speaker are disposed.

Fixed part 21B of stator 21 is attached to a holder (not shown) disposed on fix housing 12; on the other hand, guide 25B of rotary case 25 is attached to a holder (not shown) of movable housing 13, whereby fix housing 12 and movable housing 13 are journaled via opening and closing device 20.

Sound input part 12B, display 13A, sound output part 13B, and electronic circuits (not shown) disposed in fix housing 12 and movable housing 13 are electrically connected via wiring section 30 including lead wires and wiring boards. In the structure of the embodiment, wiring section 30 runs through, in a little slack state, hollow section 21A of stator 21, hollow section 23A of rotor 23, hollow section 26A of cover 26, and spring 7. The mobile phone is thus completed.

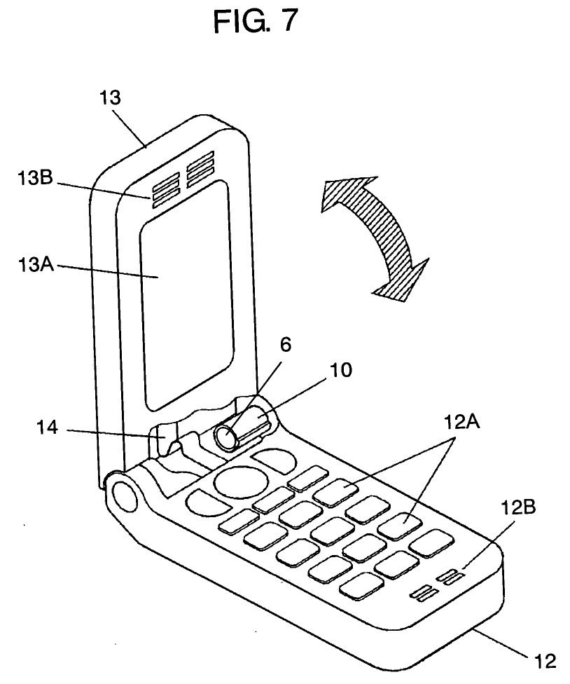

Running through the hollows formed in each component of opening and closing device 20, wiring section 30 electrically connects between fix housing 12 and movable housing 13. That is, there is no need for space to accommodate wiring section 30 therein—corresponding to the space for wiring section 14 of the conventional mobile phone shown in FIG. 7—at the connecting part between the two housings. As a result, the mobile phone can be smaller by the space.

Now will be described how the opening and closing device of the invention works in a mobile phone. FIG. 1 shows a sectional view of device 20 in the closing state of the mobile phone. In the state where the tip of rotor cam 24 makes contact with downward tilting portion 22B of stator cam 22, rotor 23 is urged downward (i.e., in the closing direction of the mobile phone) by spring 7. The urging force toward the closing direction is added, as a rotative force, from holding part 23B to the inside of guide 25B of rotary case 25, so that movable housing 13 to which rotary case 25 is fixed retains the closed state with respect to fix housing 12.

When movable housing 13 is manually unfolded from the closed state, an upward rotative force is applied, via the inside groove of guide 25B of rotary case 25 fixed to movable housing 13, to holding portion 23B of rotor 23. Under the force, rotor 23 moves with rotation toward the right in rotary case 25, while contracting spring 7. At the same time, the tip of rotor cam 24 slides over tilting portion 22B of stator cam 22 toward projecting portion 22A (i.e., upwardly in FIG. 1).

Once the tip of rotor cam 24 gets over projecting portion 22A of stator cam 22 and makes contact with upward tilting portion 22C, from then on, rotor 23 is urged upward (i.e., in the opening direction of the mobile phone) by spring 7. The upward force is applied from holding portion 23B to the inside groove of guide 25B of rotary case 25, so that movable housing 13 to which rotary case 25 is fixed retains the opened state.

Each time movable housing 13 is opened and closed, the force generated by the operations rotates rotary case 25 fixed to movable housing 13. The rotative force is applied to holding portion 23B via the inside groove of guide 25B. Under the force, rotor 23 moves with rotation in the axial direction, and the tip of rotor cam 24 makes contact with either tilting portion 22B or tilting portion 22C of stator cam 22. Movable housing 13 thus retains the opening (or closing) state with respect to fix housing 12.

According to the device of the embodiment, stator 21 and rotor 23, which are to be housed in rotary case 25, are formed into a hollow cylinder shape. In addition, eliminating columnar fix shaft 8 that has been conventionally employed allows opening and closing device 20 to have a hollow that axially runs through the device. Running through the hollow, specifically, hollow 21A of stator 21; hollow 23A of rotor 23; the inner space of spring 7; and hollow 26A of cover 26, wiring section 30 establishes electric connections between fix housing 12 and movable housing 13. By virtue of no need for preparing space for wiring section 30, the opening and closing device can be smaller, which allows electronic equipment using the device to be more compact.

FIG. 4 is a sectional view of opening and closing device 40 of another embodiment of the present invention.

Device 40 differs from aforementioned device 20 in shape of the cover; cover 46 contains disk portion 46A and cylindrical portion 46B. Disk portion 46A of the right end of cover 46 is fixed on the right side of rotary case 25. On the other hand, the left end of cylindrical portion 46B is movably inserted through hollow 21A of stator 21 that sticks out the left side of rotary case 25. Disk portion 46A has a center hole, while cylindrical portion 46B is formed into a hollow cylinder axially running through the case. With the use of cover 46, the hollow, since it runs through disk portion 46A and cylindrical portion 46B, can be used for disposing wiring section 30.

In the structure of device 20, the wiring section runs through an individual hollow section of each component. Compared to the structure of device 20, the through-the-case hollow of device 40 can prevent wiring section 30 from making contact with other components even when wiring section 30 is slacked. Therefore, wiring section 30 can be reliably held within the hollow.

Cover 46 can be rotatably attached to rotary case 25. This structure enables the tip of cylindrical portion 46B to fix in hollow 21A of stator 21.

Cover 46 of the embodiment serves as fix shaft 8 used in a conventional device. This structure enables holding stator 21 and rotor 23 properly, such that wiring section 30 can be held with further reliability.

The opening and closing device of the present invention, as described above, can be useful for various kinds of electronic equipment. Employing the device and the electronic equipment using the device encourages further downsizing of the whole structure of a product.

What is claimed is:

1. An opening and closing device comprising:
a stator having a stator cam at a side;
a rotor having a rotor cam at a side confronting the stator cam;
a rotary case for accommodating the stator so as to be rotatable, and accommodating the rotor so as to be movable in an axial direction of the case; and
a cover for covering an end of the rotary case,
wherein, the opening and closing device has an axially run-through hollow section therein.

2. The opening and closing device of claim 1, wherein each of the stator, the rotor, the rotary case, and the cover has an axially run-through hollow section therein.

3. The opening and closing device of claim 1, wherein the cover includes:
a disk portion which covers the end of the rotary case; and
a cylindrical portion in the center of the disk portion, the cylindrical portion is long enough for at least reaching an end of the stator but that does not stick out of an other end of the stator, and
a hollow section is formed so as to run through the disk portion and the cylindrical portion.

4. Electronic equipment comprising:
a) an opening and closing device including:
a-1) a stator having a stator cam at a side;
a-2) a rotor having a rotor cam at a side confronting the stator cam;
a-3) a rotary case for accommodating the stator so as to be rotatable, and accommodating the rotor so as to be movable in an axial direction of the case; and
a-4) a cover for covering an end of the rotary case,
wherein, each of the stator, the rotor, the rotary case, and the cover has an axially run-through hollow section therein; and
b) a fix housing and a movable housing that can be opened and closed via the opening and closing device; and
c) a wiring section for electrically connecting between the movable housing and the fix housing,
wherein, the wiring section is laid through the run-through hollow section.

5. The electronic equipment of claim 4, wherein the cover includes:
a disk portion which covers the end of the rotary case; and
a cylindrical portion in the center of the disk portion, the cylindrical portion is long enough for at least reaching an end of the stator but that does not stick out of an other end of the stator; and
a hollow section is formed so as to run through the disk portion and the cylindrical portion,
wherein the wiring section is laid through the hollow section of the cover.
